(19) United States
(12) Patent Application Publication
(10) Pub. No.: US 2022/0044182 A1
(43) Pub. Date: Feb. 10, 2022

(54) MANAGING MEMBERS AGAINST OPPONENTS IN AN ENCOUNTER SET IN A COMPETITIVE ENVIRONMENT

(71) Applicant: The Boeing Company, Chicago, IL (US)

(72) Inventors: Haig Francis Krikorian, Fullerton, CA (US); Leo Ho Chi Hui, Alhambra, CA (US)

(73) Assignee: The Boeing Company, Chicago, IL (US)

(21) Appl. No.: 17/352,099

(22) Filed: Jun. 18, 2021

Related U.S. Application Data
(60) Provisional application No. 63/062,703, filed on Aug. 7, 2020.

(51) Int. Cl. G06Q 10/06

(52) U.S. Cl. CPC G06Q 10/06393; G06Q 10/06398

(57) ABSTRACT

In one example aspect, a computer-implemented method or managing one or more members during an encounter in a competitive environment in a “prudent yet aggressive” fashion includes: receiving input data relating to the encounter within the competitive environment; at incrementing timesteps, executing a simulation to select different move sets during progression of the encounter, each move set defining movements or assignments of each of the one or more members as part of developing a strategy. Selecting different move sets includes: generating first move set options for containing one or more opponents by members based on the input data; selecting a first move set; generating a node identifying the selected first move set option; generating second move set options based on the node as input; selecting a second move set; determining that objectives have been met; and generating and outputting instructions associated with the first and second move sets.

### CROSS-REFERENCE TO RELATED APPLICATIONS

This patent application claims priority to and the benefit of U.S. Provisional Application No. 63/062,703 filed on Aug. 7, 2020, the entirety of which is incorporated by reference herein.

### STATEMENT REGARDING FEDERALLY SPONSORED RESEARCH OR DEVELOPMENT

This invention was made with Government support under Contract No. HQ0147-17-C-0001 awarded by The Missile Defense Agency. The Government has certain rights in this invention.

### BACKGROUND

A competitive environment may include a team of members competing against a team of opponents. Managing the positioning and assignments of members in a competitive environment may involve directing the members to move to a certain position (e.g., in a space in the competitive environment) and directing the members to perform an assigned task with the objective of neutralizing an opponent or achieving some other objective. Such management tasks may be applicable in a virtual/gaming environment, a sports environment, a combat environment (e.g., ground, air, and/or space environment), etc.

### SUMMARY

In one example aspect, a computer-implemented method or managing one or more members during an encounter in a competitive environment includes: receiving input data relating to the encounter within the competitive environment; at incrementing timesteps, executing a simulation to select different move sets during the progression of the encounter, each move set defining the movements or assignments of each of the one or more members as part of developing a strategy in the competitive environment. Selecting different move sets includes: generating first move set options for containing one or more opponents by members based on the input data; selecting a first move set; generating a node identifying the selected first move set option; generating second move set options based on the node as input; selecting a second move set; and determining that objectives have been met; and generating and outputting instructions associated with the first and second move sets.

In another example aspect, a computer program product includes a computer readable storage medium having program instructions embodied therewith. The program instructions are executable by a computing device to cause the computing device to perform operations including: receiving input data relating to the encounter within the competitive environment; at incrementing timesteps, executing a simulation to select different move sets during the progression of the encounter, each move set defining the movements or assignments of each of the one or more members as part of developing a strategy in the competitive environment. Selecting different move sets includes: generating first move set options for containing one or more opponents by members based on the input data; selecting a first move set; generating a node identifying the selected first move set option; generating second move set options based on the node as input; selecting a second move set; and determining that objectives have been met; and generating and outputting instructions associated with the first and second move sets.

In another example aspect, a system includes a processor, a computer readable memory, a non-transitory computer readable storage medium associated with a computing device, and program instructions executable by the computing device to cause the computing device to perform operations including: receiving input data relating to the encounter within the competitive environment; at incrementing timesteps, executing a simulation to select different move sets during the progression of the encounter, each move set defining the movements or assignments of each of the one or more members as part of developing a strategy in the competitive environment. Selecting different move sets includes: generating first move set options for containing one or more opponents by members based on the input data; selecting a first move set; generating a node identifying the selected first move set option; generating second move set options based on the node as input; selecting a second move set; and determining that objectives have been met; and generating and outputting instructions associated with the first and second move sets.

### BRIEF DESCRIPTION OF THE DRAWINGS

FIG. 1 illustrates an overview of an example implementation in accordance with aspects of the present disclosure.

FIG. 2 illustrates an example environment as described herein.

FIGS. 3A and 3B illustrate an example flowchart of a process for executing one or more simulations used to manage member as part of developing a strategy against opponents in an encounter set in a competitive environment, in accordance with aspects of the present disclosure.

FIG. 4 illustrates example components of a device that may be used within environment of FIG. 2.

### DETAILED DESCRIPTION

A competitive environment may include a team of members competing against a team of opponents. Managing the positioning and assignments of members in a competitive environment may involve directing the members to move to a certain position (e.g., in a space in the competitive environment) and directing the members to perform an assigned task with the objective of neutralizing an opponent, defending an asset, and/or achieving some other objective. Complexities in an encounter between members and opponents may disrupt the management of members in a competitive environment. For example, input data and/or conditions for making management decisions may be distorted, or are not always reliable, clear, consistent, or obvious. As one example, opponents in the competitive environment may be intentionally deceitful, provide obstructions, hide information, behave erratically or unpredictably, with the objective of disrupting their opponent's abilities and chances to achieve their objectives. Other complexities in an encounter may exist, such as communication clarity issues, numeric advantages/disadvantages, member positioning, member priorities, etc. The presence of such complexities may lead to hasty decisions resulting in incorrect or sub-optimal member placement and task assignments, poor team resource management, inflexibility, etc.

Accordingly, aspects of the present disclosure may include a system and/or method to simulate a variety of position movement and assignment options for members with consideration to the presence of complexities in order to optimize the value and effect of the position movement and assignments while avoiding the pitfalls of making incorrect or hasty decisions. As described herein, the systems and/or methods, described herein and in accordance with aspects of the present disclosure, may take a measured and cautious approach to position movement and assignment of members in a manner that contains the threat of opponents while allowing time to pass in which additional data may gathered and used to make subsequent position and assignment decisions for the members. In this way, threats from opponents may be contained and minimized while additional data is gathered for making more informed subsequent placement and assignment decisions that maximize the value of these decisions, maintaining member flexibility, preserving member and team resources, and improving mission success. In some embodiments, aspects of the present disclosure may consider a variety of factors for determining position movement and assignments, such as optimal containment positions, fuel consumption optimization, and/or collision avoidance to prevent position movements from resulting in collision avoidance.

As described herein, “containment” refers to the positioning of members in a competitive environment to maximize an ability to engage (e.g., reach) the opponents and/or disrupting or preventing the opponents from achieving an objective (e.g., neutralizing a friendly asset, advancing or moving beyond a containment area, etc.) as well as positioning members in such a way that maximizes the members' options to assist with engaging other opponents. As described herein, the management of team member placements and tasks, in accordance with aspects of the present disclosure, may be applicable in any variety of competitive environments, such as a virtual/gaming environment, a sports environment, a combat environment (e.g., ground, air, and/or space environment), etc. In the example of a space environment, a team may include a group of space vehicles or assets and opponents may include adversary space vehicles. In this example, the systems and/or methods, described herein and in accordance with aspects of the present disclosure, may be used to manage the movements and placements of the space vehicles within an area of the competitive environment, and to manage tasks with the objective of neutralizing opponents, defending assets, and/or performing any other variety of mission objectives. Further, the systems and/or methods, described herein, may take a measured, cautious approach to achieving mission objectives in a manner that contains threats from opponents such that complexities from an encounter (e.g., deceptive, noisy, unreliable input data, etc.) may be further analyzed and properly interpreted. In this way, subsequent movement and task assignments may be made based on more complete and properly interpreted data, thereby improving mission success. Further, as described herein, aspects of the present disclosure may develop a general strategy for a team's movements and assignments for engaging opponents to improve mission success chances even in situations where the team may be at a competitive disadvantage.

By using the iterative simulation approach described herein, a prudent encounter strategy may be developed in which members are cautiously placed in a manner that permits the members to contain the threat of opponents (while prioritizing higher value opponents and without experiencing collisions). Further, the approach described herein may allow the members to maintain position to quickly adjust, engage or contain a different opponent, and conserve resources to maintain members' capacity to best assist the team at any given time.

Certain embodiments of the disclosure will hereafter be described with reference to the accompanying drawings, wherein like reference numerals denote like elements. It should be understood, however, that the accompanying drawings illustrate only the various implementations described herein and are not meant to limit the scope of various technologies described herein. The drawings show and describe various embodiments of the current disclosure.

Embodiments of the disclosure may include a system, a method, and/or a computer program product at any possible technical detail level of integration. The computer program product may include a computer readable storage medium (or media) having computer readable program instructions thereon for causing a processor to carry out aspects of the present disclosure.

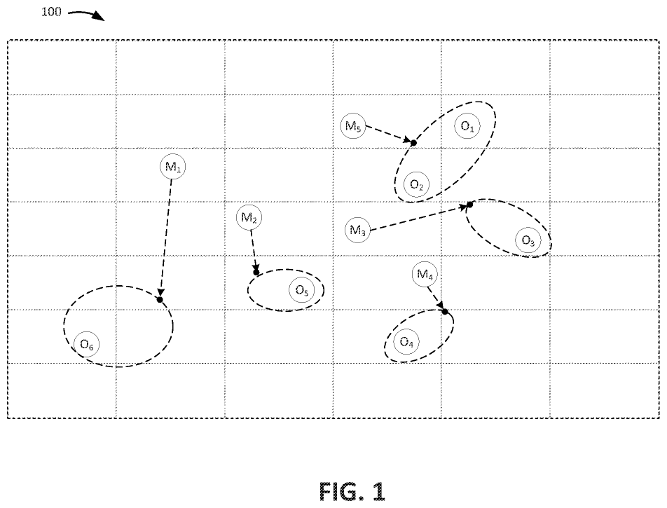

FIG. 1 illustrates an overview of an example implementation in accordance with aspects of the present disclosure. As shown in FIG. 1, a competitive environment 100 may be electronically and graphically represented in the form of a grid of an area. The competitive environment 100 may include members of a team or group (represented by points or icons labeled as “M₁” through “M₅”) and opponents of an opposing team or group (represented by points or icons labeled as “O₁” through “O₆”) that may be engaged in an encounter (e.g., a real-time or preplanned encounter). It is noted that the example competitive environment 100 shown in FIG. 1 is provided for illustrative purposes only. In practice, the boundary size/shape of the competitive environment 100 and the quantity and position of members and opponents may vary.

In some embodiments, the competitive environment 100 may be a virtual/gaming environment, a sporting environment, a combat environment (e.g., ground, air, and/or space environment), etc. Generally, a member may represent any entity (e.g., asset, individual, component, vehicle, etc.) associated with one team or group, and an opponent may represent any opposing entity associated with an opposing team or group. As one illustrative, non-limiting example, the competitive environment 100 is a space environment in which the members may be space vehicles or space assets associated with one team or group, and the opponents may be adversary space vehicles or assets associated with adversary team or group.

In some embodiments, aspects of the present disclosure may include determining the strategic movement/placement of members in the competitive environment 100 for an encounter with respect to the opponents, as well as the strategic assignment of tasks for each member to achieve a particular objective or group of objectives (e.g., objectives to contain and/or neutralize threats and/or assets from the opponents, objectives to defend one or more assets, etc.). As shown in FIG. 1, the planned movements of each member and their containment areas may be graphically represented in arrows as shown. Also, in some embodiments, the graphic representation of the competitive environment 100 may also identify the movement predictions of the opponents. In some embodiments, the containment of an opponent may involve the positioning of members in a competitive environment to maximize an ability to engage (e.g., reach) the opponents, disrupting and/or preventing the opponents from achieving an objective (e.g., neutralizing a friendly asset, advancing or moving beyond a containment area, etc.), as well as positioning members in such a way that maximizes the members' options to assist with engaging other opponents.

As described herein, the approach for placement and assignment of members during an encounter may be expressed as a “prudent and aggressive” approach in which the members are placed in a manner that avoids hasty decisions, and thus does not overcommit the members' time and resources, while leaving the members in a position to quickly shift or adjust their positions and assignments as the encounter continues over time and as more information is available over time. Further, the approach for placement and assignment of members may be such that threats from opponents may be contained to allow additional time to pass to gather additional data, resolve and properly interpret deceptive and/or noisy data, etc. Thus, as additional data is gathered and more information is gleaned as the encounter continues, subsequent placement and assignment decisions may be made from a more complete set of information. Further, as more complete information is gathered, the more aggressive the approach may be for neutralizing opposing threats and assets.

As further shown in FIG. 1, and in the spirit of taking a “prudent and aggressive” approach, movements of the members may be such that instead of members quickly and aggressively moving in a direct path to opponents, the movements may be initially more gradual so as to contain the threat of the opponents (e.g., contain the opponents' movements within a containment area). For example, with consideration to member M₁, as shown in FIG. 1, the movement of M₁ may be planned such that M₁ approaches a vicinity of O₆ in order for M₁ to contain O₆. In this way, M₁ is still in a position to assist with the servicing or engagement of O₅, as shown. Other members may be positioned in a similar manner so as to maximize containment of the opponents until additional information is gathered. Further, when a team is at a numerical disadvantage, the systems and/or methods, described herein, may assist the team to overcome this disadvantage. In the example shown in FIG. 1, five members may be facing six opponents, but using the approach described herein, all six opponents may be contained by the five members.

As described in further detail herein, the movement and task assignments for members may be based on a variety of factors with consideration to the presence of complexities. For example, different members may have different containment capabilities (e.g., area sizes that they may be able to contain), fuel levels, maneuverability capabilities, etc. Further, the attributes, positions, and/or movements of opponents may not be immediately or clearly determined. For example, opponents may take deceptive or unpredictable actions, take measures to hide their identities, or take any other variety of actions to confuse and/or disrupt the members. Accordingly, the “prudent and aggressive” approach, described herein, may result in members initially taking slower, more cautious positions such that threats from opponents may be contained, while allowing additional time to pass for deceptive, noisy, and/or incomplete data to be properly interpreted. As further described herein, the systems and/or methods described herein may take an incremental approach in which simulations are run at continuous time intervals (e.g., each second, every five seconds, 10 seconds, 20 seconds, etc.). At each incremental time interval, the prior state of the environment and the encounter may be used as input to determine subsequent actions and assignments for members.

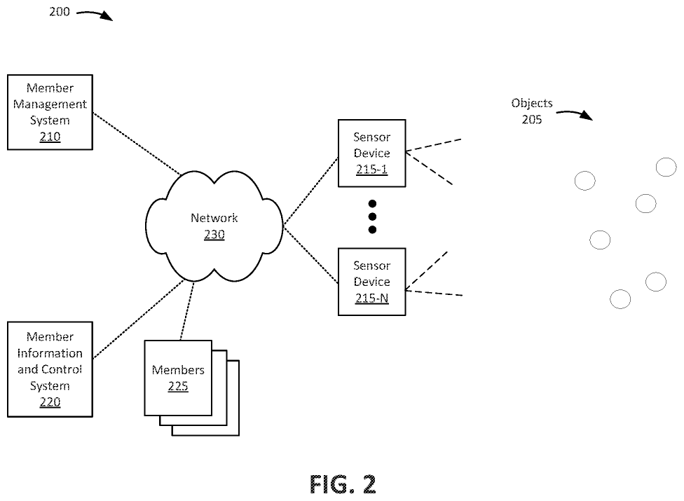

FIG. 2 illustrates an example computing environment in accordance with aspects of the present disclosure. As shown in FIG. 2, the computing environment 200 includes a member management system 210, sensor devices 215-1 through 215-N, a member information and control system 220, members 225, and a network 230.

The member management system 210 may include one or more computing devices that monitors the state of an encounter, and generates instructions to control the movement and assignment of members. In some embodiments, the member management system 210 may generate the instructions based on member information and attributes received from the member information and control system 220. Using space vehicles as an example, the member attributes may include vehicle capabilities/kinematics, types, dimensions, functions, fuel levels, fuel consumption behaviors, vehicle health/status, etc. The member management system 210 may further generate the instructions based on opponent attributes, opponent movement estimates, etc. In some embodiments, the member management system 210 may communicate with the sensor devices 215 to obtain information that may be used to derive opponent position and/or attributes. The member management system 210 may further receive input data from members 225 and/or any other “friendly” sources (e.g., sensors, observation systems, etc.). The member management system 210 may prepare the input data to generate a representation of a current state of a competitive environment (e.g., the current position and assignment of members 225, attributes of the members 225, position and attributes of opponents, etc.). As described herein, data regarding an opponent may be noisy, incomplete, and deceptive. As such, in some embodiments, the member management system 210 may fuse conflicting, noisy, and/or incomplete data to generate a “belief” or most likely estimate of the attributes and position of opponents.

In some embodiments, the member management system 210 may generate containment options (e.g., “move sets” that define possible moves that all members 225 may make during an encounter at a particular time increment). The member management system 210 may further rank the move sets based on level of containment effectiveness, determine a level of urgencies for members 225 and opponents, identify whether any move sets may involve a collision, and generate nodes representing a state of the encounter after determining that a move set has satisfied success conditions (e.g., no collisions, members 225 have been assigned to contain the highest value opponents, sufficient resources are available to execute the move set, etc.). The member management system 210 may continue to generate nodes (e.g., defining selections of move sets) that contain the opponents until a set of objectives have been met, and may provide instructions containing the nodes to the member information and control system 220 to control the movements and assignments of the members 225. As described herein, the member management system 210 may centralize the control of members 225 and/or centrally manage member 225 placement information. In this way, the member management system 210 may identify potential collisions between members 225 and make any necessary corrections for avoiding collisions.

The sensor devices 215 may include object sensor devices that may be distributed over an area for detecting objects 205 and their attributes (e.g., potential opponents or adversaries). In some embodiments, the sensor devices 215 may be implemented as part of friendly members 225 and/or as stand-alone devices. In some embodiments, the sensor devices 215 may gather raw data representing object emission properties, movement, etc. Each sensor device 215 may report, to the member 225 management system 210, a “belief” or estimation of the object's attributes and/or identity based on the collected raw data (e.g., using any suitable combination of object prediction algorithms). In some embodiments, a reported belief may include a confidence level of the object's attributes. The confidence reported by each sensor device 215 may increase over a period of time as additional data is gathered until a belief is stabilized.

As described herein, multiple different sensor devices 215 may report divergent beliefs regarding an object's attributes as a result of environmental noise, sensor design preferences for detecting certain emission properties, various scan rates, different object viewpoints and sensor positions, etc. Accordingly, the member management system 210 may implement techniques to establish a consensus belief of the object's attributes. For example, the member management system 210 may establish a belief by implementing a “stable reasoner” approach that considers the beliefs of each of the sensor devices 110, even outliers. Further, the member management system 210 may determine a cause of unstable reportings from the sensor devices 215, and in turn, determine whether conclusions made by sensor devices 215 with unstable reportings should be believed.

The member information and control system 220 may include one or more computing devices that monitor and control the operations and assignments of members 225. In some embodiments, the member information and control system 220 may provide member 225 attribute information to the member management system 210 such that the member management system 210 may use the member 225 attribute information as part of generating movement control and assignment instructions. The member information and control system 220 may also receive the movement control and assignment instructions from the member management system 210 for controlling the members 225 accordingly. Additionally, or alternatively, the member management system 210 may provide the movement control and assignment instructions directly to the members 225 without involving the member information and control system 220.

The network 230 may include network nodes and one or more wired and/or wireless networks. For example, the network 230 may include a cellular network (e.g., a second generation (2G) network, a third generation (3G) network, a fourth generation (4G) network, a fifth generation (2G) network, a long-term evolution (LTE) network, a global system for mobile (GSM) network, a code division multiple access (CDMA) network, an evolution-data optimized (EVDO) network, or the like), a public land mobile network (PLMN), and/or another network. Additionally, or alternatively, the network 240 may include a local area network (LAN), a wide area network (WAN), a metropolitan network (MAN), the Public Switched Telephone Network (PSTN), an ad hoc network, a managed Internet Protocol (IP) network, a virtual private network (VPN), an intranet, the Internet, a fiber optic-based network, and/or a combination of these or other types of networks. In embodiments, the network 230 may include copper transmission cables, optical transmission fibers, wireless transmission, routers, firewalls, switches, gateway computers and/or edge servers.

The quantity of devices and/or networks in the environment 200 is not limited to what is shown in FIG. 2. In practice, the environment 200 may include additional devices and/or networks; fewer devices and/or networks; different devices and/or networks; or differently arranged devices and/or networks than illustrated in FIG. 2. Also, in some implementations, one or more of the devices of the environment 200 may perform one or more functions described as being performed by another one or more of the devices of the environment 200. Devices of the environment 200 may interconnect via wired connections, wireless connections, or a combination of wired and wireless connections.

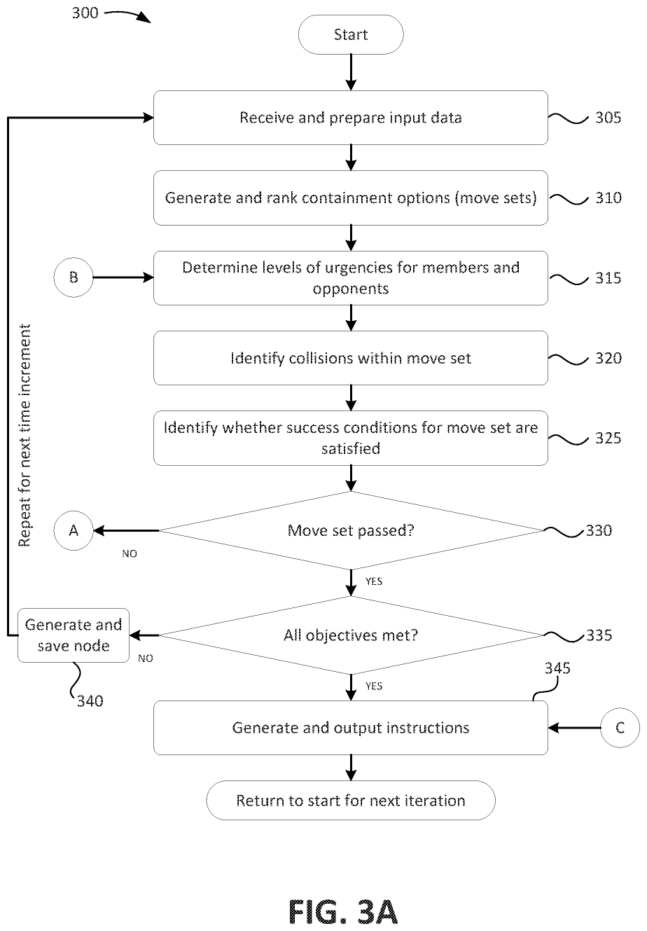

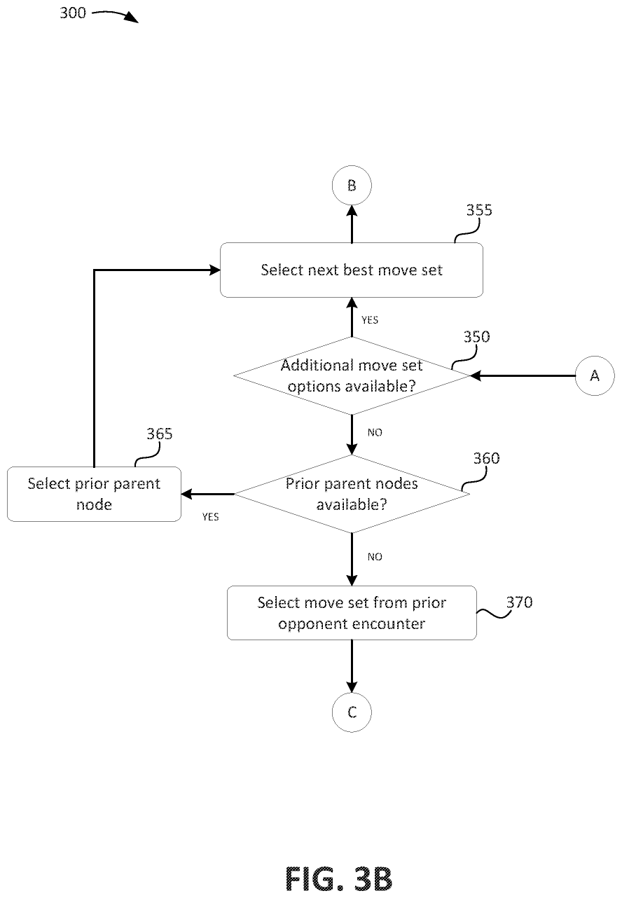

FIGS. 3A and 3B illustrate an example flowchart of a process for executing one or more simulations used to manage member 225 as part of developing a strategy against opponents in an encounter set in a competitive environment, in accordance with aspects of the present disclosure. The blocks of FIGS. 3A and 3B may be implemented in the environment of FIG. 2, for example, and are described using reference numbers of elements depicted in FIG. 2. As noted herein, the flowchart illustrates the architecture, functionality, and operation of possible implementations of systems, methods, and computer program products according to various embodiments of the present disclosure.

As described herein, the process 300 shown in FIGS. 3A and 3B may represent a simulation process for developing a strategy for members in a competitive environment. In some embodiments, the simulation process may be used to determine different moves, assignments, and/or strategy decisions for members 225 at each incrementing timestep or time iteration during an encounter in a competitive environment. Thus, the simulation described by process 300 may be repeated for each timestep or time iteration as the encounter progresses as part of the development of an overall encounter strategy for maximizing team success against an opponent in the counter. The simulation described by process 300 may be run from a current time to any future time in which the future time may or may not be the end of the encounter. Thus, the future time for which the simulation may run may be adaptive, thereby providing flexibility in developing the strategy consistent with computing resources and throughput requirements as the complexity of the encounter increases or decreases. In some embodiments, the process 300 may be performed in real-time during a current encounter and/or in advance of a pre-planned encounter.

As shown in FIG. 3A, the process 300 may include receiving and preparing input data (block 305). For example, the member management system 210 may receive and prepare input data received from any variety of input sources (e.g., members 225, sensors 215, friendly data sources, etc.). In some embodiments, preparing the input data may involve identifying the attributes, positions, predicted movements, and predicted intents of opponents in a competitive environment. As described herein, opponent behavior may not be clear or obvious and may be intentionally deceptive. Thus, different input sources may report different or conflicting beliefs for the opponents' information. Accordingly, the member management system 210 may smooth and fuse conflicting belief data from different input sources. Further, any variety of data fusion and/or smoothing techniques may be used. As one illustrative, non-limiting example, the member management system 210 may fuse belief data from multiple sources using Covariance Intersection (CI). In some embodiments, the CI output may be fused with belief data from an additional data source (e.g., an additional sensor device 215 or member 225), again using CI. This second CI output may be fused with sensor belief data from an additional data source using CI, and so on and so forth. As further described herein, the member management system 210 may apply a Kalman Filter after fusing the data to further stabilize the data and improve belief accuracy. In this way, the member management system 210 may converge towards a belief that considers all of the beliefs reported by data sources, without merely settling on an average of the data or a majority. In some embodiments, preparing the input data may include ranking members 225 based on their capabilities, and ranking opponents based on their covariance and/or value of their fused intents.

In some embodiments, preparation of the input data may include generating a representation of a competitive environment in which the representation identifies member 225 information (e.g., member 225 position, attributes, etc.) and opponent information (e.g., opponent position, attributes, etc.). In some embodiments, the representation of the competitive environment may be graphically represented (e.g., in a manner similar to FIG. 1). In some embodiments, the input data may include a node, or a data file containing information identifying a current state of the encounter and the competitive environment (e.g., based on previously simulated and saved states).

The process 300 also may include generating and ranking containment options (move sets) (block 310). For example, the member management system 210 may generate and rank containment options (i.e., move sets that define possible moves each member 225 may make). More specifically, a move set may identify options for opponents that each member 225 may engage and/or contain within the competitive environment. In some embodiments, generating the move sets may include generating individual grid positions for each member 225 according to their containment capabilities. In some embodiments, grid positions may contain a “Nash” position. The grid positions may be evaluated and ranked according to the overall containment strategy desired against the Nash position. The grid positions developed for each member 225 may be ranked and collectively constitute a “move set.” “Containment” may refer to the selection of the number and type of opponents to contain. With limited number member 225 resources compared to the number of opponents, attempting to contain all opponents may result in both spreading the defending members 225 out and/or wasting resources as compared to when a “contained set” of targets is chosen. This condition requires the input processing to rank opponent intent so that a proper subset of opponents can be selected. That is to say, a containment option (or move set) may define a possible set of grid positions to which each member 225 may move in order to contain the threat of opponents based on the opponents' intents, capabilities, predicted movements, etc. In some embodiments, the move sets may be ranked, for example, based on impact and effectiveness (e.g., the level to which higher threat opponents are contained).

The process 300 further may include determining levels of urgencies for members 225 and opponents (block 315). For example, the member management system 210 may select the highest ranked move set and determine level of urgencies for members 225 and opponents. More specifically, as the encounter unfolds, opponents may become critical (or “urgent”) at different times and may be “serviceable” (e.g., engageable for containing the opponents) by multiple members 225. As described herein, opponent may be considered “urgent” based on resource and/or timeliness constraints for servicing and/or containing opponents. As an example, an “urgent” opponent may be an opponent whose behaviors and/or actions pose an imminent or near-term threat and thus, must be quickly contained with time being of the essence. Additionally, or alternatively, an opponent may be considered “urgent” when the opponent may soon become unreachable based on resource constraints of members 225 (e.g., fuel constraints, distance contra tins, etc.). In some embodiments, a member 225 may be determined to be “urgent” when the member 225 becomes ineffective in the encounter (e.g., when a measure of the member 225's ability to engage and/or contain an opponent is less than a threshold level).

In some embodiments, urgency levels may be used as part to assign members 225 to contain certain opponents and to assign any variety of instructions for achieving an objective (e.g., a mission objective). For example, sequencing of member 225 assignments may assume that an opponent is deceptive and that any servicing of opponents may be adapted based on assessed prior, current, and projected opponent behavior. With overlapping member 225 coverage, strategy decisions may be based on information identifying members 225 ability to affect the encounter to determine “best-suited” member 225 to service an opponent (e.g., with further emphasis on servicing “urgent” opponents).

By determining urgency levels, as described herein, deceptive behaviors by opponents may be mitigated in the effort to develop a prudent encounter strategy. As described herein, opponent deceptive behavior may impact member 225 placement and assignment in multiple ways. As one example, opponents may present themselves as being more important valuable or important than they are, thereby leading to premature member 225 positioning, assignment, and engagement to a less valuable opponent, limiting player recover and reuse for later emerging higher value opponents. Conversely, opponents may present themselves as being less important than they are, thereby resulting in that opponent being prioritized lower for servicing. Another example may include highly deceptive high value opponents that break deviate from expected patterns, potentially leading to spreading members 225 out limiting their abilities to assist each other. Accordingly, determining the urgency levels at each time increment may aid in reducing the chances of making hasty decisions that may adversely affect a team's position in the encounter.

The process 300 also may include identifying collisions within the move set (block 320). For example, the member management system 210 may identify collision identifying collisions within the move set. As members 225 are moved within the dynamically changing encounter, the member management system 210 may ensure that members 225 avoid collisions with either with each other and/or with elements within the encounter environment. Example elements may include other opponents, debris/structures in the environment, etc. As described herein, the member management system 210 may centralize the control of members 225 and/or centrally manage member 225 placement information. In this way, the member management system 210 may identify potential collisions between members 225 in the move set.

The process 300 further may include identifying whether success conditions for a move set are satisfied (block 325). For example, the member management system 210 may identify whether success conditions for a move set are satisfied. One example of a success condition may include a condition that opponents whose urgency levels satisfy a threshold have all been assigned to a member 225 and/or are being contained. Another example of a success condition may include a condition that sufficient time is available to release a member 225 from a prior assignment to service a different opponent. Another example of a success condition may include a condition that sufficient resources are available for a member 225 to service an opponent. Another success condition may include a condition that no collisions between members 225, objects, and/or opponents occur (e.g., as determined at process block 320). Other success conditions relating to any variety of mission objectives may be implemented.

The process 300 also may include determining whether the move set has passed (block 330). For example, the member management system 210 may determine whether the move set has passed the success conditions (e.g., from block 325). If, for example, the move set has passed the success conditions (block 330—YES), the process 300 may further include determining whether all objectives have been met (e.g., for a particular set of moves or point in time during the encounter). If all objectives have not been met (block 335-NO), the process 300 may include generating and saving a node (block 340). For example, the member management system 210 may generate and save a node (e.g., in the form of a data file) that identifies a current state of the encounter (e.g., the position and/or assignments of members 225 and opponents, attributes of members 225 and opponents, status of the members 225 and opponents, etc.). Additionally, or alternatively, the node may include information that may be used to develop member 225 “look-there” directives based on the member 225's position relative to the opponents given the current node, move set, and simulation progression. Additionally, or alternatively, the node may include a list of unassigned members 225 and unassigned opponents for use as input when generating a subsequent next node. Additionally, or alternatively, the node may include information used to develop updated intercept times between members 225 and opponents.

As further shown in FIG. 3A, the process 300 may return to block 305 in which the simulation is repeated for a next time increment in which movements and assignments for members 225 for the next time increment are determined in accordance with the process 300 as described herein. On a subsequent iteration, the node or current state of the encounter may be used as input data and as part of the decision-making processes for a subsequent set of member 225 placement and assignment instructions. For example, receiving and preparing the input data (at block 305) may involve using the node generate at 340 as input data and containment options may be generated based on this input data (e.g., at block 310). In this way, the member management system 210 may take an iterative approach in which a complete situational analysis is performed at each iterative timestep of the encounter and nodes identifying the state of the encounter may be maintained at each interval and used for determining subsequent moves and assignments. Further, as time progresses, additional data is available to make more prudent strategy decisions and moves while containing opponent threats at each time increment and maintaining member 225 position in a manner that allows members 225 to make relatively quick adjustments.

In some embodiments, the process 300 may continue until all objectives have been met (e.g., process block 335—YES). Once all objectives have been met, the process 300 may include generating and outputting instructions (block 345). For example, the member management system 210 may generate and output instructions to the members 225 (e.g., to control systems linked to the members 225, such as the member information and control system 220). Examples may include instructions for members 225 to move to particular locations, contain particular opponents, and the behaviors and actions to take in connection with containing and/or neutralizing opponents. The process 300 may return to the start in which the simulation may be repeated for a subsequent move set in the overall encounter strategy. In this way, the encounter strategy may be developed for member 225 assignment and movements using an interactive approach in which input data, current encounter state information, urgency levels, collision avoidance information, and/or success conditions are iteratively analyzed at each timestep, and movement and assignments may be determined at each timestep to avoid overcommitting and/or making hasty decisions.

If, at block 330, a move set has not passed success conditions (block 330-NO), the process 300 further may include determining whether additional move set options are available (block 350, referring to FIG. 3B). For example, the member management system 210 may determine whether additional move set options are available (e.g., from the ranked list generated at block 310) in a situation in which success conditions have not been met (e.g., if the threat of a collision is present, if high value opponents are not reachable, if resources are insufficient to execute the move set, etc.). If, for example, additional move sets are present (block 350—YES), the process 300 may include selecting the next best move set (block 355), and returning to block 310 in which the next best (or next highest ranked) move set is selected and analyzed for urgency levels, collisions, and success conditions. In this way, the process 300 may eliminate move sets that do not satisfy success conditions.

If, on the other hand no additional move set options are available (block 350-NO), the process 300 may include determining whether prior parent nodes are available (block 360). For example, the member management system 210 may determine whether any previous nodes were saved (e.g., if the simulation had been previously been executed for a prior time increment). If a parent node is available (block 360—YES), the process may include selecting a prior parent node (block 365) and selecting a next best move set from that prior parent node (block 355). For example, the member management system 210 may “back-track” to the find that move set from which to examine the encounter by selecting the next move set option of the parent node (e.g., which may be akin to a recurse best first search technique).

If, on the other hand, prior parent node are not available (block 360-NO), the process 300 may include selecting a move set from a prior opponent encounter (block 370). For example, the member management system 210 may select a move set from a prior opponent encounter as the best available move set, and the process 300 may return to block 345 in which instructions are generated and outputted for the selected move set.

By using the interactive simulation approach described herein, a prudent encounter strategy may be developed in which members 225 are cautiously placed in a manner that permits the members 225 to contain the threat of opponents (while prioritizing higher value opponents and without experiencing collisions) while also allowing the members 225 to maintain a position to quickly make adjustments, engage or contain a different opponent, and conserve resources to maintain members' 225 capacity to best assist the team at any given time.

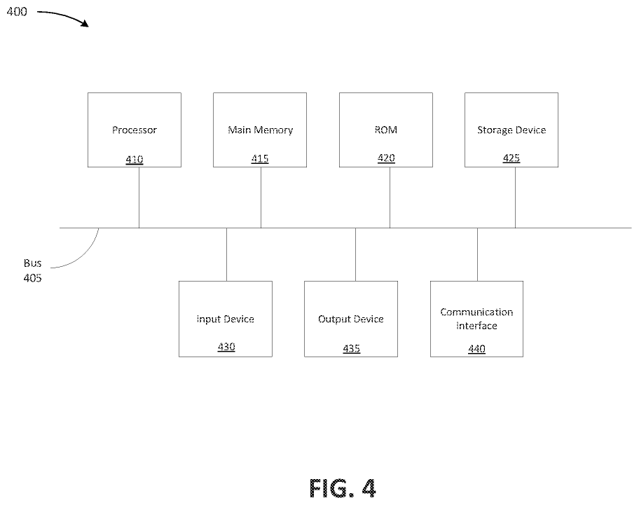

FIG. 4 illustrates example components of a device 400 that may be used within environment 200 of FIG. 2. Device 400 may correspond to the member management system 210, the member information and control system 220, and/or members 225. Each of member management system 210, the member information and control system 220, and/or members 225 may include one or more devices 400 and/or one or more components of device 400.

As shown in FIG. 4, device 400 may include a bus 405, a processor 410, a main memory 415, a read only memory (ROM) 420, a storage device 425, an input device 430, an input device 435, and a communication interface 440.

Bus 405 may include a path that permits communication among the components of device 400. Processor 410 may include a processor, a microprocessor, an application specific integrated circuit (ASIC), a field programmable gate array (FPGA), or another type of processor that interprets and executes instructions. Main memory 415 may include a random access memory (RAM) or another type of dynamic storage device that stores information or instructions for execution by processor 410. ROM 420 may include a ROM device or another type of static storage device that stores static information or instructions for use by processor 410. Storage device 425 may include a magnetic storage medium, such as a hard disk drive, or a removable memory, such as a flash memory.

Input device 430 may include a component that permits an operator to input information to device 400, such as a control button, a keyboard, a keypad, or another type of input device. Input device 435 may include a component that outputs information to the operator, such as a light emitting diode (LED), a display, or another type of output device. Communication interface 440 may include any transceiver-like component that enables device 400 to communicate with other devices or networks. In some implementations, communication interface 440 may include a wireless interface, a wired interface, or a combination of a wireless interface and a wired interface. In embodiments, communication interface 440 may receiver computer readable program instructions from a network and may forward the computer readable program instructions for storage in a computer readable storage medium (e.g., storage device 425).

Device 400 may perform certain operations, as described in detail below. Device 400 may perform these operations in response to processor 410 executing software instructions contained in a computer-readable medium, such as main memory 415. A computer-readable medium may be defined as a non-transitory memory device and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. A memory device may include memory space within a single physical storage device or memory space spread across multiple physical storage devices.

The software instructions may be read into main memory 415 from another computer-readable medium, such as storage device 425, or from another device via communication interface 440. The software instructions contained in main memory 415 may direct processor 410 to perform processes that will be described in greater detail herein. Alternatively, hardwired circuitry may be used in place of or in combination with software instructions to implement processes described herein. Thus, implementations described herein are not limited to any specific combination of hardware circuitry and software.

In some implementations, device 400 may include additional components, fewer components, different components, or differently arranged components than are shown in FIG. 4.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the disclosure may include a system, a method, and/or a computer program product at any possible technical detail level of integration. The computer program product may include a computer readable storage medium (or media) having computer readable program instructions thereon for causing a processor to carry out or execute aspects and/or processes of the present disclosure.

In embodiments, the computer readable program instructions may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on a user's computer, partly on the user's computer, as a stand-alone software package, partly on the user's computer and partly on a remote computer or entirely on the remote computer or server.

In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

In embodiments, a service provider could offer to perform the processes described herein. In this case, the service provider can create, maintain, deploy, support, etc., the computer infrastructure that performs the process steps of the disclosure for one or more customers. These customers may be, for example, any business that uses technology. In return, the service provider can receive payment from the customer(s) under a subscription and/or fee agreement and/or the service provider can receive payment from the sale of advertising content to one or more third parties.

The foregoing description provides illustration and description, but is not intended to be exhaustive or to limit the possible implementations to the precise form disclosed. Modifications and variations are possible in light of the above disclosure or may be acquired from practice of the implementations.

It will be apparent that different examples of the description provided above may be implemented in many different forms of software, firmware, and hardware in the implementations illustrated in the figures. The actual software code or specialized control hardware used to implement these examples is not limiting of the implementations. Thus, the operation and behavior of these examples were described without reference to the specific software code—it being understood that software and control hardware can be designed to implement these examples based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

While the present disclosure has been disclosed with respect to a limited number of embodiments, those skilled in the art, having the benefit of this disclosure, will appreciate numerous modifications and variations there from. It is intended that the appended claims cover such modifications and variations as fall within the true spirit and scope of the disclosure.

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

What is claimed is:

1. A computer-implemented method for managing one or more members during an encounter in a competitive environment comprising:
receiving, by a computing device, input data relating to the encounter within the competitive environment;
at incrementing timesteps, executing, by the computing device, a simulation to select different move sets during progression of the encounter, each move set defining movements or assignments of each of the one or more members as part of developing a strategy in the competitive environment, the selecting different move sets comprising:
generating, by the computing device, a first plurality of move set options for containing one or more opponents by the one or more members based on the input data;
selecting, by the computing device, a first move set, of the first plurality of move set options;
generating, by the computing device, a node identifying the selected first move set option;
generating, by the computing device, a second plurality of move set options based on the node as input;
selecting, by the computing device, a second move set of the second plurality of move set options; and
determining, by the computing device, that objectives have been met based on outcomes of the first move set and the second move set; and
generating and outputting, by the computing device, instructions associated with the first and second move sets to the one or more members.

2. The method of claim 1, further comprising ranking the first plurality of move set options, wherein the selecting the first move set comprises selecting a highest ranked move set of the first plurality of move sets.

3. The method of claim 1, further comprising determining levels of urgencies for the one or more members or the one or more opponents, wherein the selecting the first move set is based on the levels of urgencies for the one or more members or the one or more opponents.

4. The method of claim 1, further comprising determining that no collisions occur within the first move set, wherein the selecting the first move set is based on determining that no collisions occur within the first move set.

5. The method of claim 1, further comprising determining that success conditions for the first move set have not passed and selecting a prior available move set or a prior parent node based on the determining that success conditions for the first move set have not passed.

6. The method of claim 1, further comprising determining measures of general containment effectiveness for the one or more members or the one or more opponents, wherein the selecting the first move set is based on the measure of general containment effectiveness.

7. The method of claim 1, further comprising preparing the input data prior to the executing the simulation, the preparing the input data comprising performing belief fusion of different beliefs of attributes, positions, predicted movements, or predicted intents of opponents.

8. A computer program product comprising a computer readable storage medium having program instructions embodied therewith, the program instructions executable by a computing device to cause the computing device to perform operations comprising:
receiving input data relating to the encounter within competitive environment;
at incrementing timesteps, executing a simulation to select different move sets during progression of the encounter, each move set defining movements or assignments of each of one or more members as part of developing a strategy in the competitive environment, the selecting different move sets comprising:
generating a first plurality of move set options for containing one or more opponents by the one or more members based on the input data;
selecting a first move set of the first plurality of move set options;
generating a node identifying the selected first move set option;
generating a second plurality of move set options based on the node as input;
selecting a second move set of the second plurality of move set options; and
determining that objectives have been met based on outcomes of the first move set and the second move set; and
generating instructions associated with the first and second move sets to the one or more members.

9. The computer program product of claim 8, wherein the operations further comprise ranking the first plurality of move set options, wherein the selecting the first move set comprises selecting a highest ranked move set of the first plurality of move sets.

10. The computer program product of claim 8, wherein the operations further comprise determining levels of urgencies for the one or more members or the one or more opponents, wherein the selecting the first move set is based on the levels of urgencies for the one or more members or the one or more opponents.

11. The computer program product of claim 8, wherein the operations further comprise determining that no collisions occur within the first move set, wherein the selecting the first move set is based on determining that no collisions occur within the first move set.

12. The computer program product of claim 8, wherein the operations further comprise determining that success conditions for the first move set have not passed and selecting a prior available move set or a prior parent node based on the determining that success conditions for the first move set have not passed.

13. The computer program product of claim 8, wherein the operations further comprise determining measures of general containment effectiveness for the one or more members or the one or more opponents, wherein the selecting the first move set is based on the measure of general containment effectiveness.

14. The computer program product of claim 8, wherein the operations further comprise preparing the input data prior to the executing the simulation, the preparing the input data comprising performing belief fusion of different beliefs of attributes, positions, predicted movements, or predicted intents of opponents.

15. A system comprising:
a processor, a computer readable memory, a non-transitory computer readable storage medium associated with a computing device, and program instructions executable by the computing device to cause the computing device to perform operations comprising:
receiving input data relating to the encounter within competitive environment;
at incrementing timesteps, executing a simulation to select different move sets during progression of the encounter, each move set defining movements or assignments of each of one or more members as part of developing a strategy in the competitive environment, the selecting different move sets comprising:
generating a first plurality of move set options for containing one or more opponents by the one or more members based on the input data;
selecting a first move set of the first plurality of move set options;
generating a node identifying the selected first move set option;
generating a second plurality of move set options based on the node as input;
selecting a second move set of the second plurality of move set options; and
determining that objectives have been met based on outcomes of the first move set and the second move set; and
generating instructions associated with the first and second move sets to the one or more members.

16. The system of claim 15, wherein the operations further comprise ranking the first plurality of move set options, wherein the selecting the first move set comprises selecting a highest ranked move set of the first plurality of move sets.

17. The system of claim 15, wherein the operations further comprise determining levels of urgencies for the one or more members or the one or more opponents, wherein the selecting the first move set is based on the levels of urgencies for the one or more members or the one or more opponents.

18. The system of claim 15, wherein the operations further comprise determining that no collisions occur within the first move set, wherein the selecting the first move set is based on determining that no collisions occur within the first move set.

19. The system of claim 15, wherein the operations further comprise determining that success conditions for the first move set have not passed and selecting a prior available move set or a prior parent node based on the determining that success conditions for the first move set have not passed.

20. The system of claim 15, wherein the operations further comprise determining measures of general containment effectiveness for the one or more members or the one or more opponents, wherein the selecting the first move set is based on the measure of general containment effectiveness.
